(19) United States
(12) Patent Application Publication
(10) Pub. No.: US 2024/0147918 A1
(43) Pub. Date: May 9, 2024

(54) CONTROLLED ENVIRONMENT AGRICULTURE SYSTEM

(71) Applicant: W. L. Gore & Associates, Inc., Newark, DE (US)

(72) Inventors: Edward H. Cully, Clarksville, VA (US); Eric Dufford, Flagstaff, AZ (US); Jeffrey B. Duncan, Flagstaff, AZ (US)

(21) Appl. No.: 18/282,089

(22) PCT Filed: Mar. 14, 2022
(86) PCT No.: PCT/US2022/020160

§ 371 Date: Sep. 14, 2023

Related U.S. Application Data
(60) Provisional application No. 63/161,259, filed on Mar. 15, 2021.

(51) Int. Cl. A01G 9/14; A01G 9/24

(52) U.S. Cl. CPC A01G 9/1415; A01G 9/1438; A01G 9/246

(57) ABSTRACT

A controlled environment agriculture system is provided, in which the system includes an inner layer and an outer layer. At atmospheric conditions, the inner layer is air permeable, water vapor permeable, and liquid water impermeable, and the outer layer is water vapor impermeable and liquid water impermeable. An enclosure defined by the inner layer is disposed within the interior space of an enclosure defined by the outer layer, and a primary spacing is maintained between at least a portion of the outer surface of the inner layer and the inner surface of the outer layer.

### CROSS-REFERENCE TO RELATED APPLICATION

The present application is a national phase application of PCT Application No. PCT/US2022/020160, internationally filed on Mar. 14, 2022, which claims benefit of U.S. Provisional Application No. 63/161,259, filed on Mar. 15, 2021, which are herein incorporated by reference in their entireties for all purposes.

### FIELD

The present disclosure relates generally to agricultural environments, and more specifically to a controlled agricultural environment and the components thereof.

### BACKGROUND

Indoor agriculture systems have become more popular in recent years. Generally, care must be taken in setting up and maintaining such systems. Different plants require different amounts of light, water, and air composition, as well as different types of nutrients.

One common system for such purposes is a greenhouse. There are numerous challenges in building and maintaining greenhouses that can be utilized to grow a variety of plants, and particularly when attempting to grow different types of plants or plants under different growth cycles within the same overall space. For example, various types of environmental controls must be put in place to artificially control the greenhouse environment to enhance plant growth, and those environmental controls may be relatively inflexible within the greenhouse growing space.

### SUMMARY

Disclosed herein are embodiments and examples of an agriculture system in a controlled environment. According to one example (“Example 1”), the agriculture system includes a primary enclosure forming a growing space for one or more photosynthetic organisms. The primary enclosure has a sidewall that includes an inner layer that is air permeable, water vapor permeable, and liquid water impermeable at atmospheric conditions. The inner layer has an inner surface with a diffuse reflectivity of at least 90%. The agriculture system also includes a secondary enclosure defining an interior space. The primary enclosure is disposed within the interior space of the secondary enclosure.

According to another example (“Example 2”) further to Example 1, the primary enclosure is arranged within the secondary enclosure such that the primary enclosure exhibits a primary set of environmental conditions while the secondary enclosure exhibits a secondary set of environmental conditions different from the primary set of environmental conditions.

According to another example (“Example 3”) further to Example 1 or 2, the secondary enclosure is configured as one or more of: a residential housing unit, a mobile container unit, and a commercial building unit.

According to another example (“Example 4”) further to any preceding Example, the primary enclosure is coupled to an environmental exchanger.

According to another example (“Example 5”) further to Example 4, the environmental exchanger includes a translation mechanism coupled to the primary enclosure, the translation mechanism being configured to move the primary enclosure within the secondary enclosure.

According to another example, (“Example 6”) further to Example 5, the translation mechanism includes one or more of a lift mechanism, an expansion mechanism, and an agitation mechanism for moving the sidewall of the primary enclosure.

According to another example (“Example 7”) further to any one of Examples 4 through 6, the environmental exchanger is configured to encourage at least one of relative humidity, temperature exchange, or gas exchange from the primary enclosure.

According to another example (“Example 8”) further to Example 4, the environmental exchanger includes one or more conduits in communication with the sidewall.

According to another example (“Example 9”) further to Example 8, the one or more conduits are configured to exchange at least one of humidity, temperature, or gas through the inner layer of the primary enclosure.

According to another example (“Example 10”) further to Example 8 or 9, the one or more conduits are configured to collect and convey water vapor condensate from the growing space that passes through the inner layer.

According to another example (“Example 11”) further to Example 10, at least one of the one or more conduits includes one or more portions characterized as one or more of: asymmetrical, transparent, opaque, varying in size, varying in shape, hydrophilic, hydrophobic, filled, coated, and metallized.

According to another example (“Example 12”) further to any preceding Example, the sidewall further comprises one or more electrically and/or thermally conductive elements in communication with the inner layer.

According to another example (“Example 13”) further to any preceding Example, the sidewall further comprises one or more conduits that include one or more portions characterized as one or more of asymmetrical, transparent, opaque, of varying size and shape, hydrophilic, hydrophobic, filled, coated, and metallized.

According to another example (“Example 14”) further to any preceding Example, the system includes an additional primary enclosure forming an additional growing space for one or more additional photosynthetic organisms. The additional primary enclosure has a sidewall that includes an inner layer that is air permeable, water vapor permeable, and liquid water impermeable at atmospheric conditions. The inner layer of the additional primary enclosure has an inner surface with a diffuse reflectivity of at least 90%. The additional primary enclosure is also disposed within the secondary enclosure.

According to another example (“Example 15”) further to Example 14, the primary enclosure is configured to support growth of a first variety of photosynthetic organism and the additional primary enclosure is configured to support growth of a second variety of photosynthetic organism different from the first variety of photosynthetic organism.

According to another example (“Example 16”) further to any preceding Example, the system includes a light source associated with the primary enclosure to provide light to the growing space of the primary enclosure.

According to another example (“Example 17”) further to Example 16, the light source is integrated with the sidewall of the primary enclosure.

According to another example (“Example 18”) further to Example 1, the sidewall of the primary enclosure further includes a second layer separated from the inner layer. Optionally, the sidewall further includes a support structure, the inner layer and the second layer being coupled to the support structure such that the inner layer is separated from the second layer.

According to another example (“Example 19”) further to Example 18, the second layer is water vapor impermeable at ambient conditions.

According to another example (“Example 20”) further to Example 18, the second layer is less porous than the inner layer.

According to another example (“Example 21”) further to any one of Examples 18 through 20, the second layer has a light transmissivity of less than 10%.

According to another example (“Example 22”) further to any one of Examples 18 through 21, the second layer includes a rigid panel.

Further disclosed herein are agriculture methods. According to one example (“Example 23”), the agricultural method includes disposing a primary enclosure within an interior space of a secondary enclosure, where the primary enclosure has a sidewall that includes an inner layer that is air permeable, water vapor permeable, and liquid water impermeable at atmospheric conditions, and the inner layer has an inner surface with a diffuse reflectivity of at least 90%. The method also includes providing reflected light from the sidewall of the primary enclosure to one or more photosynthetic organisms within a growing space defined by the primary enclosure.

According to another example (“Example 24”) further to Example 23, the secondary enclosure is at a secondary set of environmental conditions, and the primary enclosure maintains the growing space at a primary set of environmental conditions different from the secondary set of environmental conditions.

According to another example (“Example 25”) further to Example 23 or 24, the secondary enclosure is at a secondary set of environmental conditions, and the primary enclosure maintains the growing space at a primary set of environmental conditions different from the secondary set of environmental conditions.

According to another example (“Example 26”) further to any one of Examples 23 through 25, the secondary enclosure is configured as one or more of a residential housing unit, a mobile container unit, and a commercial building unit.

According to another example (“Example 27”) further to any one of Examples 23 through 26, the method further includes encouraging at least one of humidity exchange, temperature exchange, or gas exchange from the primary enclosure with an environmental exchanger coupled to the primary enclosure.

According to another example (“Example 28”) further to Example 27, the environmental exchanger includes a translation mechanism coupled to the primary enclosure, and method includes moving, via the translation mechanism, the primary enclosure within the secondary enclosure to maintain the growing space of the primary enclosure at a primary set of environmental conditions different from the secondary set of environmental conditions.

According to another example (“Example 29”) further to Example 28, the translation mechanism moves the primary enclosure by lifting, expanding, or agitating the sidewall of the primary enclosure.

According to another example (“Example 30”) further to Example 27, the environmental exchanger includes one or more conduits in communication with the sidewall of the primary enclosure.

According to another example (“Example 31”) further to any one of Examples 23 through 30, the method further includes passively removing at least one of humidity, O₂, and odor from the growing space of the primary enclosure through the sidewall using.

According to another example (“Example 32”) further to any one of Examples 23 through 31, the method includes recovering one or more of humidity and O₂ generated by the one or more photosynthetic organisms within a growing space defined by the primary enclosure.

According to another example (“Example 33”) further to any one of Examples 23 through 32, the method includes disposing an additional primary enclosure within the secondary enclosure. The additional primary enclosure also has a sidewall that includes an inner layer that is air permeable, water vapor permeable, and liquid water impermeable at atmospheric conditions, and the inner layer of the additional primary enclosure also has an inner surface with a diffuse reflectivity of at least 90%. The method further includes providing reflected light from the sidewall of the additional primary enclosure to one or more additional photosynthetic organisms within a growing space defined by the additional primary enclosure, the one or more additional photosynthetic organisms.

According to another example (“Example 34”) further to Example 33, the primary enclosure and the additional primary enclosure are configured to provide different sets of environmental conditions from one another.

According to another example (“Example 35”) further to Example 28, the translation mechanism is also coupled to the additional primary enclosure, and the method further includes moving, via the translation mechanism, the primary enclosure and the additional primary enclosure in different directions relative to each other within the secondary enclosure to maintain the respective growing spaces at different sets of environmental conditions from each other.

Further disclosed herein are embodiments and examples of a horticultural growth chamber. According to one example (“Example 36”), the horticultural growth chamber includes an inner layer having a diffuse reflectivity and a first porosity sufficient to allow water vapor to pass therethrough, an outer layer positioned external to the inner layer such that a space is defined between the inner layer and the outer layer, and a water recovery system coupled with the space between the inner layer and the outer layer. The outer layer has a second porosity that is less than the first porosity of the inner layer such that the outer layer inhibits water vapor from passing through the outer layer. The water recovery system configured to collect condensate formed on the outer layer.

According to another example (“Example 37”) further to Example 36, the water recover system comprises a conduit in fluid communication with the space between the inner layer and the outer layer and a collection reservoir coupled with the conduit to store the collected condensate for future reuse.

According to another example (“Example 38”) further to Example 36 or 37, the horticultural growth chamber includes one or more additional functional layers arranged between the inner layer and the outer layer.

According to another example (“Example 39”) further to Example 36 or 37, the horticultural growth chamber includes one or more additional functional layers arranged external to the outer layer.

According to another example (“Example 40”) further to Example 38 or 39, the one or more additional functional layers define one or more of: a conditioned space between the inner and outer layers with controlled temperature, an insulation space between the inner and outer layers, a wiring channel between the inner and outer layers, or a plumbing channel between the inner and outer layers.

According to another example (“Example 41”) further to Example 40, the one or more functional layers are configured to be independently activated via delivery of a fluid through the one or more functional layers.

According to another example (“Example 42”) further to any one of Examples 36 through 41, the diffuse reflectivity of the inner layer is at least 90%.

According to another example (“Example 43”) further to any one of Examples 36 through 42, the outer layer further comprises one or more conduits configured to transport a heat transfer fluid.

According to another example (“Example 44”) further to any one of Examples 36 through 43, at least one of the inner and outer layers is rigid.

According to another example (“Example 45”) further to any one of Examples 36 through 43, at least one of the inner and outer layers is flexible.

According to another example (“Example 46”) further to any one of Examples 36 through 43, at least one of the inner and outer layers has at least one rigid portion and at least one flexible portion.

Further disclosed herein are embodiments and examples of a controlled environment agriculture system. In one example (“Example 47”), the system includes an inner layer with an inner surface and an outer surface, as well as an outer layer with an inner surface and an outer surface. The inner layer is air permeable, water vapor permeable, and liquid water impermeable at atmospheric conditions. The inner surface of the inner layer has a diffuse reflectivity of at least 90%. The inner layer defines a first enclosure forming a growing space for one or more photosynthetic organisms. The outer layer is water vapor impermeable and liquid water impermeable at atmospheric conditions. The outer layer defines a second enclosure comprising an interior space such that the first enclosure is disposed within the interior space of the second enclosure, and a primary spacing is maintained between at least a portion of the outer surface of the inner layer and the inner surface of the outer layer.

According to another example (“Example 48”) further to Example 47, the system includes a support structure attached to at least one of the inner and outer layers to maintain the primary spacing.

According to another example (“Example 49”) further to Example 47, the outer layer includes a support structure integrated therein to maintain the primary spacing.

According to another example (“Example 50”) further to Example 47, the inner layer includes a support structure integrated therein to maintain the primary spacing.

According to another example (“Example 51”) further to any one of Examples 48-50, the support structure is a rigid member.

According to another example (“Example 52”) further to any one of Examples 48-51, at least one additional functional layer is disposed externally with respect to the outer layer. The additional functional layer includes an inner surface and an outer surface, and maintains a secondary spacing between at least a portion of the outer surface of the outer layer and the inner surface of the additional functional layer.

According to another example (“Example 53”) further to Example 52, the support structure is attached to the additional functional layer to maintain the secondary spacing.

According to another example (“Example 54”) further to Example 52 or 53, the secondary spacing defines one or more of: a conditioned space, an insulation space, a wiring channel, or a plumbing channel.

According to another example (“Example 55”) further to any one of Examples 52-54, the additional layer is independently activatable via delivery of a fluid through the additional layer.

According to another example (“Example 56”) further to any one of Examples 52-55, the outer layer or the additional layer includes one or more conduits configured to transport a heat transfer fluid.

According to another example (“Example 57”) further to any one of Examples 52-56, the system includes a plurality of additional functional layers disposed externally with respect to the outer layer. Each of the plurality of additional functional layers is disposed externally with respect to a preceding one of the plurality of additional functional layers such that the secondary spacing is maintained between at least a portion of an inner surface of the each of the additional functional layers and an outer surface of the preceding one of the plurality of additional functional layers.

According to another example (“Example 58”) further to Example 57, an outermost one of the plurality of additional functional layers is formed of a light-absorbent material or includes a light-absorbent coating applied to an outer surface thereof.

According to another example (“Example 59”) further to Example 58, at least one of the plurality of additional functional layers disposed internally with respect to the outermost one of the plurality of additional functional layers comprises a thermally or electrically insulative material.

According to another example (“Example 60”) further to Example 58 or 59, an inner surface of the at least one of the plurality of additional functional layers disposed internally with respect to the outermost one of the plurality of additional functional layers is at least partially metallized.

In one example (“Example 61”), a controlled environment agriculture system promotes the growth of a photosynthetic organism within the controlled environment agriculture system. The system includes a primary enclosure defining a growing space housing the photosynthetic organism within the primary enclosure, the primary enclosure having an inner layer separating the growing space from a moisture-collection space external to the inner layer. The inner layer is air permeable, water vapor permeable, and liquid water impermeable at atmospheric conditions. The inner layer maintains an air pressure gradient between the growing space and the moisture-collection space that coveys water vapor from the growing space to the moisture-collection space. The inner layer and the air pressure gradient removes an excessive moisture from the growing space to inhibit at least one of a bacterial and a fungal growth within the growing space.

According to another example (“Example 62”) further to Example 61, the inner layer has a diffuse reflectivity of at least 90%.

According to another example (“Example 63”) further to Example 61 or 62, the system includes an outer layer disposed proximate to at least a portion of the inner layer to further define the moisture-collection space, wherein the outer layer is water vapor impermeable and liquid water impermeable at atmospheric conditions.

Further disclosed herein are embodiments and examples of a method of controlling a moisture level within a growing space housing a photosynthetic organism. In one example (“Example 64”), the method includes separating the growing space from an adjacent moisture-collection space with an inner layer that is air permeable, water vapor permeable, and liquid water impermeable at atmospheric conditions, applying an air pressure gradient wherein the growing space is maintained at a greater air pressure than the moisture-collection space, and transferring moisture from the growing space to the moisture-collection space via the inner layer.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIGS. 1A and 1B illustrate a controlled environment agriculture system with a primary enclosure disposed within a secondary enclosure in accordance with embodiments disclosed herein;

FIG. 2 illustrates a primary enclosure in accordance with embodiments disclosed herein;

FIG. 3 is a partial view of a sidewall with support structure in accordance with embodiments disclosed herein;

FIG. 4A is a partial view of another sidewall with support structure in accordance with embodiments disclosed herein;

FIG. 4B is a cross-sectional view of another sidewall with support structure in accordance with embodiments disclosed herein;

FIG. 5 illustrates a controlled environment agriculture system with a plurality of primary enclosures disposed within the secondary enclosure in accordance with embodiments disclosed herein;

FIG. 6 is a schematic diagram of an environmental exchanger in accordance with embodiments disclosed herein;

FIG. 7 illustrates a counterbalance actuation system as implemented in the environmental exchanger in accordance with embodiments disclosed herein;

FIG. 8 is a cross-sectional view of conduit assemblies in an inner layer in accordance with embodiments disclosed herein;

FIG. 9 is a cross-sectional view of another example of conduit assemblies in an inner layer in accordance with embodiments disclosed herein;

FIG. 10 illustrates another primary enclosure in accordance with embodiments disclosed herein;

FIG. 11 is a partial view of the layers in a sidewall in accordance with embodiments disclosed herein;

FIG. 12 is a flow diagram for a process of how a primary enclosure functions as disclosed herein; and

FIG. 13 is a flow diagram for another process of how a primary enclosure functions as disclosed herein.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

Certain terminology is used herein for convenience only. For example, words such as “top”, “bottom”, “upper,” “lower,” “left,” “right,” “horizontal,” “vertical,” “upward,” and “downward” merely describe the configuration shown in the figures or the orientation of a part in the installed position. Indeed, the referenced components may be oriented in any direction. Similarly, throughout this disclosure, where a process or method is shown or described, the method may be performed in any order or simultaneously, unless it is clear from the context that the method depends upon certain actions being performed first.

The term “diffusive transmission” as used herein refers to the passage or movement of light, or electromagnetic waves, through a material, after which the light is scattered, or the unidirectional beam is deflected into many directions. The term “diffusive transmittance” describes the effectiveness of the material in transmitting the radiant energy from the light.

As used herein, the term “diffusive reflection” refers to scattered reflection of light (e.g., originating from a unidirectional beam). As used herein, the term “diffusive reflectance” describes the effectiveness of the material in reflecting the radiant energy from light.

As used herein, the term “transmissivity” refers to a degree to which a medium allows any electromagnetic radiation such as visible light, ultraviolet light, etc., to pass through it.

### Description of Various Embodiments

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting. It is also to be understood that the terms “photosynthetic organism” and “plant” may be interchangeably used herein.

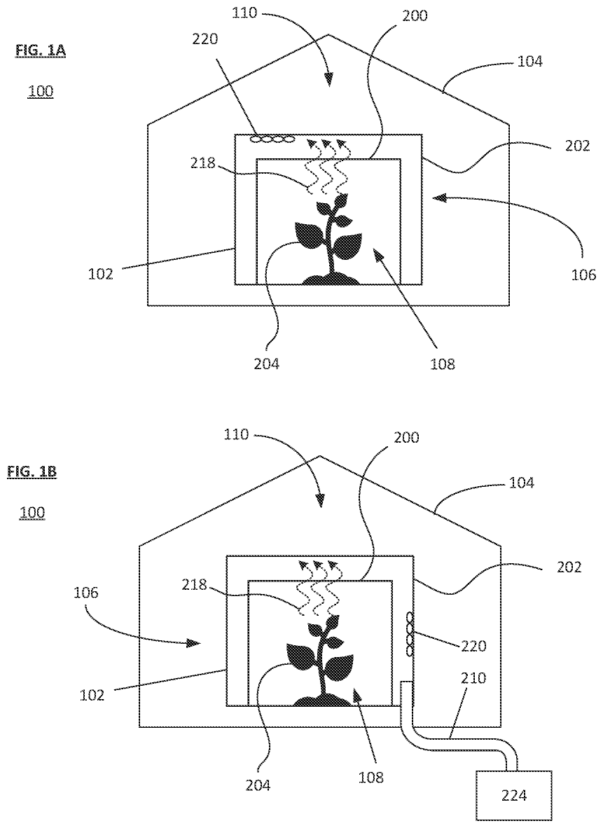

FIGS. 1A and 1B show a controlled environment agriculture system 100 according to embodiments disclosed herein. The agriculture system 100 includes a primary enclosure 102 disposed within a secondary enclosure 104. The secondary enclosure 104 has a larger size than the primary enclosure 102 and may provide structural support to house the primary enclosure 102 in some examples. The secondary enclosure 104 may be a preexisting structure in which the primary enclosure 102 is disposed, for example any building, such as a residential housing unit, a mobile container unit, a commercial building unit, a warehouse, a greenhouse, a shed, a pole barn, a farmhouse, or other suitable structure. The secondary enclosure 104 may at least partially segregate the interior of the secondary enclosure 104 from the surrounding atmosphere, including external objects, temperature, humidity, gasses, and/or particulate present in a surrounding ambient environment outside of the secondary enclosure 104

The primary enclosure 102, which may also be referred to as a horticultural growth chamber, has a growing space 108 defined by a sidewall 106 which at least partially segregates the growing space 108 from the surrounding atmosphere, including external objects, temperature, humidity, gasses, and/or particulate present in a surrounding ambient environment 110 within the secondary enclosure 104. The primary enclosure 102 may be arranged within the secondary enclosure 104 such that the primary enclosure 102 exhibits a primary set of environmental conditions while the secondary enclosure 104 exhibits a secondary set of environmental conditions different from the primary set of environmental conditions. That is, the primary enclosure 102 may be configured to promote the condition in which the environmental conditions within each of the enclosures 102, 104 are different from each other. In various examples, the differences are passively and/or actively controlled by an operator of the system.

In FIGS. 1A and 1B, the primary enclosure 102 is shown with a sidewall 106 having a first layer or inner layer 200 and a second layer or outer layer 202. The inner layer 200 optionally has a sufficient permeability (e.g., a microporous structure) to facilitate transpiration 218 from a photosynthetic organism 204 inside it to form water vapor within the growing space 108, and water vapor from the transpiration 218 permeates through the inner layer 200. The outer layer 202 is optionally less permeable than the inner layer 200 to facilitate collecting or reclaiming of the water vapor such that condensation forms condensate 220 on a surface of the outer layer 202. In applications where water collection would be desired, as shown in FIG. 1B, a conduit 210 may be disposed at the outer layer 202 to collect the condensate 220 which flows downward due to gravity. As shown, a tank or reservoir 224 can be coupled with the conduit 210 to collect the water coming from the enclosure 102. Thus, the conduit 210 and the reservoir 224 form part of a water recovery system.

In some embodiments, the reservoir 224 is positioned within ambient environment 110 within the secondary enclosure 104. In some embodiments, the reservoir 224 is positioned external to the secondary enclosure 104, such as a water tank located outside of the building or facility which defines the secondary enclosure 104. In some embodiments, there are a plurality of primary enclosures 102, as further disclosed herein, and the reservoir 224 is configured to collect water from each of the primary enclosures 102. In such embodiments, the collected water may be redistributed such that the primary enclosure(s) 102 with the least amount of water can obtain the water collected from other primary enclosure(s) 102 that has more water collected from transpiration. For example, the redistributing of the collected water may be achieved using sprinklers or irrigation pipes (or any other suitable means of water redistribution) built into the primary enclosures 102. In some embodiments, the collected water can be redistributed without undergoing water treatment, since the water reclaimed via transpiration and condensation is sufficiently clean and has minimal amount of contaminant such as chemicals or microbes.

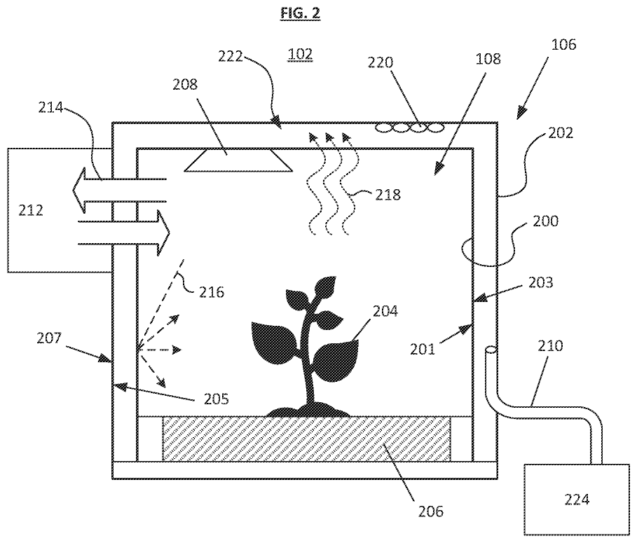

FIG. 2 illustrates the primary enclosure 102 according to some embodiments. The sidewall 106 of the enclosure 102 includes the first layer or inner layer 200 and the second layer or outer layer 202. The inner layer 200 defines a growing space 108. As shown, a plant, or photosynthetic organism 204, may be disposed inside the enclosure 102 within the growing space 108 defined by the inner layer 200. As further explained herein, the sidewall 106 may include additional functional layers.

In some examples, the controlled environment agriculture system 102 includes the inner layer 200 having an inner surface 201 and an outer surface 203, as well as the outer layer 202 having an inner surface 205 and an outer surface 207. The inner layer 200 may be air permeable, water vapor permeable, and liquid water impermeable at atmospheric conditions. The inner surface 201 may have a diffuse reflectivity of at least 90%, and the inner layer 200 may define a first, smaller enclosure which forms the growing space 108 for the photosynthetic organism(s) 204. The outer layer 202 may be water vapor impermeable and liquid water impermeable at atmospheric conditions. The outer layer 202 may define a second, larger enclosure which includes an interior space such that the first enclosure (forming the growing space 108) is disposed within the interior space of the second enclosure, and a primary spacing or space 222 is maintained between at least a portion of the outer surface 203 of the inner layer 200 and the inner surface 205 of the outer layer 202. Furthermore, a volume of the second enclosure may be defined as approximately the same as a sum of the growing space 108 of the first enclosure and the space 222.

In some examples, the organism 204 is disposed in a growth medium 206, which may be any type of growth medium suitable for the organism 204. The growth medium generally contains the appropriate nutrient(s) necessary for the growth. For example, if the organism 204 is a plant, the growth medium 206 may include soil or, in the case of hydroponic system of horticulture, aqueous solvent. The growth medium 206 may include additives, such as mineral nutrient solutions. As an additional example, the growth medium 206 may be agar if the organism 204 is photosynthetic bacteria, or other photosynthetic organism amenable to such a growth medium.

In some examples, the primary enclosure 102 defines the growing space 108 which houses the photosynthetic organism 204 within the primary enclosure 102. The primary enclosure 102 has the inner layer 200 which separates the growing space 108 from the space 222 which functions as a moisture-collection space, positioned external to the inner layer 200. At atmospheric conditions, the inner layer 200 may be permeable to air and water vapor but impermeable to liquid water. The inner layer 200 maintains an air pressure gradient between the growing space 108 and the moisture-collection space 222 that coveys water vapor from the growing space 108 to the moisture-collection space 222. The inner layer 200 and the air pressure gradient facilitate removing an excessive moisture from the growing space 108 to inhibit at least one of a bacterial and a fungal growth within the growing space 108.

In some examples, the inner layer 200 has a diffuse reflectivity of at least 90%. In some examples, an outer layer 202 may be disposed proximate to at least a portion of the inner layer 200 to further define the moisture-collection space 222. The outer layer 202 may be impermeable to water vapor and liquid water at atmospheric conditions. For example, the moisture level within the growing space 108 may be facilitated by separating the growing space 108 from the adjacent space 222, which may be the moisture-collection space, with the inner layer 200. An air pressure gradient may be applied, using any suitable means, such that the growing space 108 maintains a greater air pressure than the moisture-collection space. The moisture may be transferred from the growing space 108 to the moisture-collection space via the inner layer 200.

In some embodiments, the enclosure 102 includes any of a variety of environmental controls. For example, in some embodiments, the enclosure 102 includes a light source and/or an irrigation system 208 to provide light and/or water to the growing space 108. In some embodiments, one or more environmental controls, such as the light source 208, may be integrated with the sidewall 106 of the enclosure 102. One or more electrically and/or thermally conductive elements (not shown) may be coupled with the sidewall 106 in communication with the inner layer 200 to facilitate incorporation of one or more environmental controls with the enclosure 102. For example, the electrically conductive elements may be used to power the light source 208. The one or more environmental controls may be integrated as a single unit or provides as physically separate systems as desired. For example, the light source and irrigation 208 may be incorporated in a unitary device (for example, a lamp with a built-in sprinkler) or separate devices. The light source may be an LED light, UV light, or other suitable source that is housed directly on the sidewall 106 in a flexible manner (e.g., as a printed, deposited, or otherwise incorporated flex circuit component).

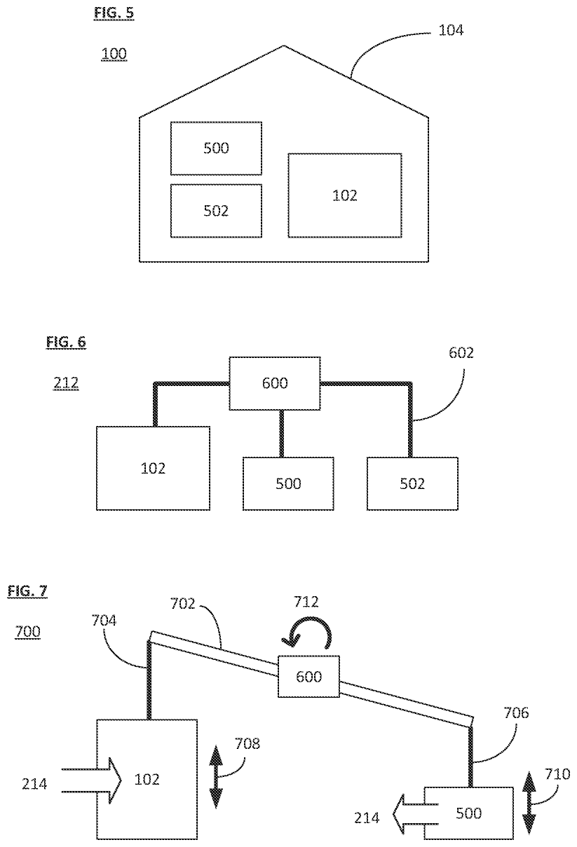

The outer layer 202 is coupled with a conduit 210 configured to collect liquid (e.g., water droplets) that collects on an inner surface of the outer layer 202. In some embodiments, the outer layer 202 is configured to operate as an environmental exchanger 212, which allows for airflow 214, and/or other environmental exchange, into and out of the enclosure 102, as explained further in FIG. 6. In some embodiments, the environmental exchanger 212 may include an air-to-air exchanger (e.g., an electrically powered fan) associated with the sidewall 106. In some embodiments, the conduit 210 assists with exchanging at least one of humidity, temperature, and/or gas through the inner layer 200 of the primary enclosure 102. Although only one conduit 210 is shown, any number of conduits may be implemented as suitable.

The inner layer 200 has an inner surface 201 which allows for incident light from a light source to be diffusely reflected such that the light is dispersed or scattered throughout the enclosure 102. The inner layer 200 may be made of a material with high diffusive reflectance value for the organism to help obtain as much light as possible from various directions. A reflective material may be used to contain and disperse the light, whether it is from the sun or from an artificial light source, that has entered the enclosure 102 or generated inside the enclosure 102. For example, the material used in forming the inner layer may be a polymeric membrane material with a high diffusive reflectance. The inner layer may be formed of, or otherwise include micro-porous, conformable, and light reflective materials. In some embodiments, the layer is formed of an expanded fluoropolymer material, such as expanded polytetrafluoroethylene (ePTFE). The material of the layer may generally be in the form of a membrane, or thin film that is relatively conformable, or drapeable. Though ePTFE is an example of a suitable material, the layer may include other types of expanded polymers, such as expanded polyethylene (ePE). For example, the layer may include one or more sublayers of ePE, etc. In some examples, the material may be a nonwoven material such as ePTFE, ePE, or nonwoven polyethylene (PE), for example. In some examples, the material may be a woven material such as a woven fabric of ePTFE, PE, polyethylene terephthalate (PET), nylon(s), and/or any combination/blend thereof, for example, and the woven material may be treated with a hydrophobic coating disposed on a surface thereof.

When a ray of light reflects off a surface, the direction in which the light travels varies depending upon the angle of the surface at which the ray of light is reflecting. As such, if the surface is considerably smooth, the ray of light consistently reflects off the surface at the same angle, therefore creating a specular reflection (e.g., a mirror-like reflection of light from the surface). An example of a surface with high specular reflectance is a mirror, which reflects all components of the light almost equally and the reflected specular light follows the same angle from the normal angle, as does the incident light. On the contrary, the microstructure of reflective inner layer 200 allows for the incident light to be dispersed in various angles depending upon which specific location of the surface the light is reflected.

One example of light dispersion can be achieved using a rough surface. The rough surface causes light to be reflected across a variety of different angles. Therefore, the diffuse light reflected from a rough surface travels in many different directions. The surface may be roughed through various processing techniques, including lasing, etching, mechanical abrasion, calendaring, just to name a few. In some examples, the microstructure of the material itself is porous or micro-porous, and thereby exhibits diffuse light reflection. And, in various examples, a combination of the microstructure and surface modification such as those referenced above may be implemented in order to achieve a desired light dispersion characteristic.

For example, the material of the reflective inner layer may be a polymeric membrane material with a high diffusive reflectance. The reflective inner layer may be formed of, or otherwise include microporous, conformable, and light reflective materials. In some embodiments, the reflective inner layer is formed of an expanded fluoropolymer material, such as expanded polytetrafluoroethylene (ePTFE). The material of the reflective inner layer may generally be in the form of a membrane, or thin film that is relatively conformable, or drapeable. Though ePTFE is an example of a suitable material, the reflective inner layer may include other types of expanded polymers, such as expanded polyethylene (ePE). For example, the reflective inner layer may include one or more layers of ePE, such as gel-processed or paste-processed ePE, for additional reflectance in the sidewall. The one or more ePE layers may be relatively thin (e.g., less than 0.500 mm) and strong, and be conformable and insulative.

In some embodiments, the sidewall 106 includes a plurality of layers, which may have differing properties (e.g., thickness, permeability, reflectivity, diffusivity, hydrophobicity or hydrophilicity, or others). As such, the layers may be arranged to modify one or more characteristics of the inner layer, such as transmissivity, reflectance, air and/or water or water vapor permeability, or other characteristic. For example, some examples include a first layer of ePTFE film (e.g., less than 0.5 mm thick) and a second layer of ePE film (e.g., less than 0.5 mm thick). The second layer of ePE film may be implemented as a backer layer, for example.

In some examples, the microstructures include highly fibrillated, or essentially nodeless, structures as desired. In some examples, the ePTFE membrane reflective layer includes a fibrillated microstructure (comprising a plurality of fibrils interconnecting a plurality of nodes) to refract light.

For reference, the term “refraction” pertains to a change in direction of the light waves when they bounce off a surface. In various examples provided herein, the fibrils comprising the fibrillated microstructure change the direction of incoming light, which may redirect light to other nearby fibrils, which may be redirected to additional nearby fibrils, and so forth. As the fibrils continue refracting the light beam amongst themselves, the fibrils may be said to cause the light beams to “bounce around” within the confinement of the enclosure formed by the membrane.

Some advantages of using ePTFE membrane as the material for the reflective layer include its resistance to oxidation and degradation. Because ePTFE membrane is chemically inert to nearly all media ranging from pH levels of 0 (maximum acidity) to 14 (maximum alkalinity), has a wide range of thermal resistance from −268° C. to +315° C., and is physiologically inert, the ePTFE reflective layers can tolerate the heat output of indoor lighting system for a prolonged period without degrading or melting.

The maximum diffuse reflectance of the inner layer 200 may be 90% or higher, 95% or higher, 97% or higher, 98% or higher, or 99% or higher depending upon the material that is used. In some embodiments, the maximum reflectance of the inner layer 200 is from about 90% to about 95%, from about 95% to about 97%, from about 97% to about 98%, from about 98% to 99%, or from about 99% to about 99.5%. In some embodiments, an average reflectance of the inner wall is from about 90% to about 95%, from about 95% to about 97%, from about 97% to about 98%, from about 98% to 99%, or from about 99% to about 99.5%.

In addition to the above, reflective layers formed from ePTFE membrane, or other types of expanded membranes can leverage various other advantages of such materials, including the ability to adjust, or tailor permeability (e.g., through porosity) to achieve additional functionality. For example, membrane permeability can be selected such that liquid vapor and/or gas can permeate through the material pores (e.g., at or around standard atmospheric pressure or at another relative pressure, as desired) to facilitate gas exchange to promote plant growth. For example, for plants that need carbon dioxide to grow, the permeability of the inner layer can be selected to allow carbon dioxide to pass through the inner layer into the growing space to facilitate plant growth while preventing or reducing the amount of unwanted contaminants (e.g., other gasses, particles or other contaminants) passing to the inside of the enclosure. If desired, the ability to pass gasses through the inner layer (e.g., pressurized gas) may be utilized to clean dust or other contaminants from the inner layer. For example, dust, dirt, or other contaminants attached to the surface of the reflective layers can reduce reflectance of the layers. The permeability of the inner layer may be utilized to occasionally let pressurized gases pass through the inner layer to dislodge particles that may be attached to the layers. In one example, pressurized carbon dioxide gas may be used to clean the inner surface of the inner layer (e.g., by locating pressurized carbon dioxide outside of the inner layer and directing the carbon dioxide through the inner layer). In this example, because carbon dioxide is denser than air, the carbon dioxide may helpfully sink downward, carrying the dislodged particles downward and away from the inner surface of the inner layer (e.g., to settle on a bottom surface away from the inner layer).

Apart from the reflectance of the layer(s), the size of the pores therein (or porosity of the layer) can also be adjusted as needed to control porosity or permeability, in some instances. For example, in an agricultural environment, having the layers be permeable to air, water vapor, and carbon dioxide may be an important factor when considering the porosity of the layers. In some examples, the size of the pores may be small enough to allow air in but inhibits water vapor from passing through the layers to maintain a dry environment, which may be especially important for facilities specializing in microfabrication or nanofabrication, where even a small amount of water contamination causes problems such as short-circuiting of microdevices. The pores of the layer may be adjusted to be selectively permeable to certain substances at or around the standard atmospheric pressure of 1013.25 mbar. The typical range of atmospheric pressure in which these layers remain permeable may be from about 980 mbar to about 1040 mbar.

Although carbon dioxide has been provided as one example of a potential gas that may be delivered through the inner layer, other gases that may be beneficial to plant growth may also be delivered through the inner layer. For example, appropriate doses of hydrogen sulfide may enhance plant growth in certain circumstances, and ethylene may also stimulate desirable plant effects, such as the ripening of fruits. These are just a few examples, and from the foregoing it should be appreciated the permeability of the inner layer can be selected to allow any of a variety of gases to be delivered into or out of the growing space as desired.

Also, as previously mentioned, the reflective inner layer may have a permeability selected to permit a desired amount of water vapor to pass through the inner layer (e.g., in order to control humidity within the growing space, minimize condensate formed on the inner layer surface resulting from transpiration or irrigation excess, and/or facilitate water reclamation from the growing space).

Referring again to FIG. 2, transpiration 218 from the photosynthetic organism 204 may form water vapor inside the growing space 108. In various examples, the inner layer 200 is air permeable (breathable), water vapor permeable, and liquid water impermeable at atmospheric conditions (e.g., having a porosity, coating, fillers or otherwise being configured to promote such features). In some examples air (or gas) and water vapor can passively permeate through the inner layer 200 without the use of any additional accessories such as air blower or airduct. In other examples, positive pressure may be maintained inside the inner layer 200 or negative relative pressure outside the inner layer 200 to help actively direct air (or gas) and water vapor through the inner layer 200. The outer layer 202 may be separated from the inner layer 200, and may have different properties from the inner layer 200. For example, the outer layer 202 may have different permeability than the inner layer (e.g., being less porous than the inner layer 200) and may be water vapor impermeable at ambient or other selected conditions. If desired, the outer layer 202 may be liquid water impermeable while still being air and water vapor permeable at atmospheric or other selected conditions.

In some examples, the permeability of the inner layer 200 and the outer layer 202 may vary depending upon the type of gas in the air. For example, the air in the Earth's atmosphere generally includes nitrogen, oxygen, and trace amounts of other types of gas, the composition of which varies based upon the layer of the Earth's atmosphere. The standard scientific unit of measurement for the composition of gases that make up the air at sea level is known as Standard Dry Air, which includes nitrogen, oxygen, argon, carbon dioxide, neon, helium, krypton, hydrogen, and xenon in different amounts. In some examples, the inner layer 200 may be less permeable with respect to carbon dioxide, since photosynthetic organism requires carbon dioxide to grow, but more permeable with respect to water vapor and other types of gas in the atmosphere to facilitate humidity and/or temperature control.

In some examples, to facilitate growth, additional carbon dioxide may be infused through the inner layer 200 to facilitate growth, and the outer layer 202 may be less permeable (or impermeable) with respect to carbon dioxide such that most, if not all, of the infused carbon dioxide remains inside the enclosure. In some examples, other methods of adding carbon dioxide may be implemented, such as adding a canister of carbon dioxide inside the enclosure or adding a container with carbon dioxide-releasing organism contained therein. In some examples, the surface of the inner layer 200 and/or outer layer 202 may have a microporous structure that is treated or coated with a polymeric coating, including but not limited to urethane or hydrogel, to affect the permeability of the layer with respect to the different types of gas, thereby forming a gas-selective membrane to facilitate the containment of gases that are favorable to the growth of the photosynthetic organism while facilitating purging of the undesirable gases, liquids, and/or solids therethrough.

In some examples, the surface of the inner layer 200 and/or outer layer 202, which may be coated with polymeric materials including but not limited to a coating of hydrogel such as polyurethane hydrogel, prevents contamination of the micro-porous structure while facilitating release of water vapor from within the enclosure. In some examples, the rate of water vapor permeability may be variable depending upon the relative humidity and/or temperature. For example, the polymeric coating may facilitate different permeability rates, or flow rates, for the different types of gas. In some examples, the inner layer 200 facilitates releasing water vapor therethrough at a faster flow rate than other gases such as carbon dioxide, oxygen, and nitrogen. In some examples, different types of gas excluding water vapor, such as carbon dioxide, oxygen, and nitrogen, may have different flow rates with respect to each other such that the inner layer 200 facilitates separating the different types of gas from each other by varying the flow rate of each type of gas.

Because the water vapor permeability of the outer layer 202 differs from (e.g., is less than) that of the inner layer 200, the outer layer 202 prevents or inhibits a sufficient amount of water vapor from passing through the outer layer such that condensate 220 forms on a surface of the outer layer 202 in a space 222 between the inner layer 200 and the outer layer 202. The condensate 220 can then be collected by the conduit 210, or through another collection mechanism, to be stored in a collection reservoir 224 (e.g., a tank). The reservoir 224 may be part of a water recovery system coupled with the space 222 between the inner layer 200 and the outer layer 202 such that the water recovery system collects the condensate 220 formed on the outer layer 202 for future reuse.

In some embodiments, a temperature gradient and/or pressure gradient applied to the enclosure 102 to facilitate condensation which forms the condensate 220. A temperature and/or pressure gradient may be naturally or artificially facilitated using a variety of suitable means. For example, heat from the lamp or light 208 causes temperature inside the enclosure 102 to rise, whereas the external atmosphere or the ambient environment 110 may be maintained at a lower temperature using air conditioning. In another example, space between the outer layer 202 and another layer positioned external to the outer layer 202 may have a lower temperature than that within the growing space 108. In either case, the temperature difference creates a temperature gradient, which facilitates condensation to form condensate 220 on the outer layer 202. In some cases, the temperature difference may also cause pressure gradient. In another example, lifting and/or lowering the enclosure 102 with the environmental exchanger 212 causes a pressure change within the growing space 108, thereby facilitating the formation of a pressure gradient.

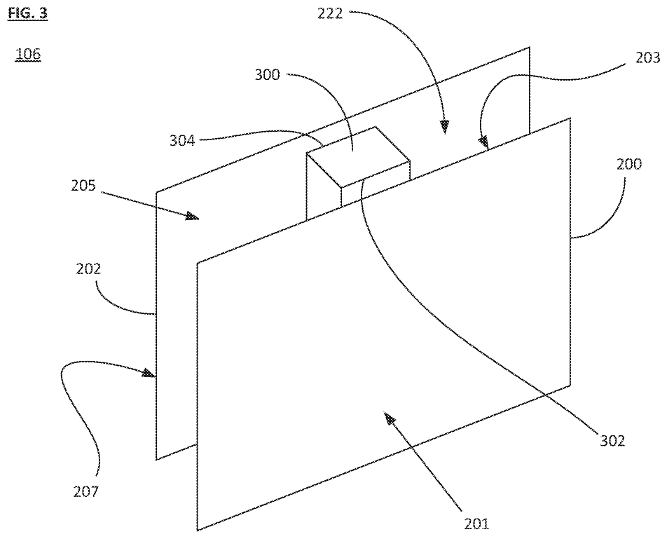

FIG. 3 illustrates an embodiment of the sidewall 106 in which the inner layer 200 and the outer layer 202 are separated and supported by a support structure 300 which may be a solid structure such as a beam or frame to hold the layers together. For example, the support structure 300 may be a rectangular beam with a first side 302 which comes into contact with the inner layer 200 and a second side 304 opposing the first side 302 which comes into contact with the outer layer 202, thereby forming the gap or space 222 between the layers. In some examples, the support structure 300 may be attached to at least one of the inner layer 200 and the outer layer 202 to maintain the space 222 therebetween. For example, the support structure 300 may be at least partially attached to the outer surface 203 of the inner layer 200 and to the inner surface 205 of the outer layer 202 to maintain the space 222. In some examples, the remaining surfaces (inner surface 201 of the inner layer 200 and outer surface 207 of the outer layer 202) may be attached to another, additional support structure which may be the same as or different from the support structure 300.

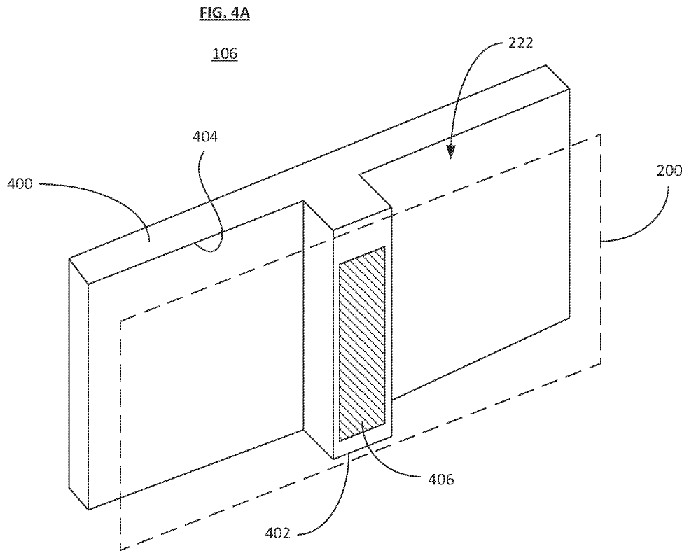

FIG. 4A illustrates an embodiment of the sidewall 106 in which the outer layer 202 and the support structure 300 from FIG. 3 are replaced with a support structure or rigid panel 400. The support structure 400 may be a unitary piece of material, such as plastic or other suitable type of rigid polymer, for example, and has a protruded portion 402 and a recessed portion 404. In some embodiments, the support structure 400 is made of metal. The protruded portion 402 supports the inner layer 200, so the inner layer 200 and the recessed portion 404 define the space 222. In some embodiments, adhesive 406 is used to attach the inner layer 200 to the support structure 400.

In some embodiments, the first side 302 of the support structure 300 or the surface of the protruded portion 402 of the support structure 400 is covered with a layer of laminate or other material which helps couple (e.g., adhere or bond) to the inner layer 200 when the sidewall 106 is heated to a predetermined temperature. For example, if the inner layer 200 is made of ePTFE which has a melting point of 327° C. and the laminate layer is made of another polymer with a lower melting point than ePTFE, heating both the inner layer 200 and the laminate layer to reach a temperature above the lower melting point but below 327° C. causes only the laminate layer to at least partially melt to cause the inner layer 200 to adhere to the support structure 300 or 400 while retaining the physical properties of the inner layer 200. If desired, additional adhesives or other coupling mechanisms may also be employed.

In some examples, the support structure 400 may be integrated in the outer layer 202 such that the protruded portion 402 may be integrated in the outer layer 202 to maintain the space 222. For example, the support structure 400 may be unitary and continuous with respect to the outer layer 202, and the protruded portion 402 may be a portion protruding from the outer layer 202. The support structure 400 or the protruded portion 402 may be a sufficiently rigid member as compared to the outer layer 202 (or the remaining portions of the outer layer 202 that is not integrated with the support structure 400) to provide structural support for the outer layer 202.

FIG. 4B illustrates an embodiment where the inner layer 200 further includes a support structure 408 integrated therein to maintain the space 222 formed between the outer surface 203 of the inner layer 200 and the inner surface 205 of the outer layer 202. For example, the support structure 408 may be unitary and continuous with respect to the inner layer 200 and/or may be formed as a protrusion or an extension from the outer surface 203 of the inner layer 200. The support structure 408 may be a sufficiently rigid member as compared to the remaining portions of the inner layer 200 to provide structural support for the inner layer 200. In some examples, the support structure may be formed by applying polymeric material(s) on the outer surface 203 of the inner layer 200, and the polymeric material(s) may provide the rigid structure to facilitate structural support for the inner layer 200, such as by the hardening or rigidifying of the polymeric material(s).

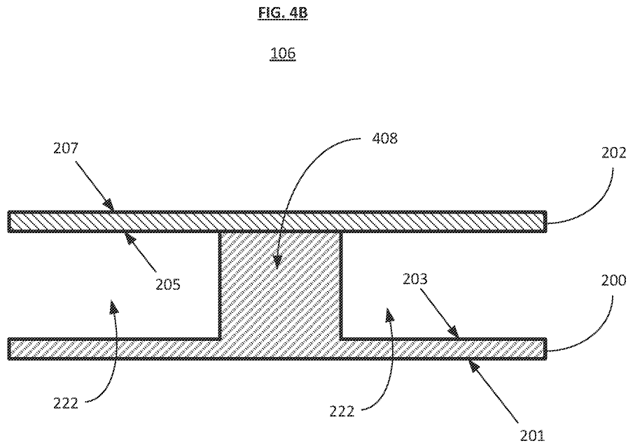

FIG. 5 shows another example of the controlled environment agriculture system 100 with a plurality of primary enclosures disposed within the secondary enclosure 104. That is, in addition to the aforementioned primary enclosure 102, there may be any number of additional primary enclosures (e.g., two as shown) in the form of additional primary enclosures 500 and 502, each having its own separate sidewall and growing space. Any number of enclosures can be disposed within the secondary enclosure 104 as permitted by the available space within the secondary enclosure 104. Each of the primary enclosures 102, 500, and 502 may have a growing space with a different set of environmental conditions from each other, or alternatively, some or all of the environmental conditions may be the same. In various examples, each additional primary enclosure has a sidewall that includes an inner layer that is air permeable, water vapor permeable, and liquid water impermeable at atmospheric conditions, with the inner layer of the additional primary enclosure having an inner surface with a diffuse reflectivity of at least 90%. In some embodiments, the plurality of primary enclosures support growth of different varieties of photosynthetic organisms such that each enclosure is controlled to maintain the optimal growing environment for the specific variety of photosynthetic organism contained therein.

The positioning of the enclosures 102, 500, and 502 is not limited to the two-dimensional layout of the secondary enclosure 104. In some embodiments, the enclosure 500 may be positioned above the enclosure 502 such that the enclosure 500 is suspended in midair, disposed on a shelf or mezzanine, or otherwise supported in a vertical position so as to elevate the enclosure 500 with respect to the enclosure 502, in order to better utilize the available three-dimensional space within the secondary enclosure 104. Because each enclosure has its own light source and/or irrigation, or other environmental controls, positioning an enclosure directly above another enclosure has no adverse effect on the amount of light or water obtained by the enclosure that is located beneath it.

In some embodiments, the outer layer 202 of each primary enclosure 102, 500, and 502 is made of a material with a light transmissivity of less than 10% such that less than 10% of the light from the outside reaches the growing space 108 within each enclosure. In some examples, the transmissivity is less than 5%, less than 3% less than 1%, or any other value therebetween. In some examples, the outer layer 202 has 0% transmissivity to completely isolate the region within from the external environment. Having less light passing through the sidewall 106 is important when growing multiple types of photosynthetic organisms, since different organisms may require different amount of light to grow at an optimal speed and/or may require effective cycling of light which may be promoted by blocking out natural or ambient light sources, such as the sun. The amount of light as described herein is defined as the length of time during each day in which light is provided to the organism in addition to the intensity of the light that is being provided. As an illustrative example, leafy vegetables such as lettuce grow in shaded areas requiring less sunlight (lower intensity light), whereas some crops such as tomatoes, peppers, and beans benefit from being grown in areas with full sunlight (higher intensity light).

In some examples, the material comprising the outer layer 202 has high absorptance. Absorptance of a material is determined by the following mathematical formula: % absorptance=100%−(% reflectance+% transmissivity). In order to decrease the light transmissivity, and to reduce the amount of light that the material reflects back to the external environment, a material of higher absorptance may be used, as suitable. On the other hand, the inner layer 200 may comprise a material of low absorptance such that more light may be reflected within the enclosure to be absorbed by the organism inside.

In one illustrative example, the primary enclosure 102 can be used to grow tomatoes, the primary enclosure 500 can be used to grow saffron, and the primary enclosure 502 can be used to grow lettuce. These crops require different environments for optimal growth, since tomatoes require full sunlight, lettuce requires less sunlight, and saffron grows well in an environment similar to 1300 to 2300 meters above sea level, for example. The enclosures can be changed accordingly to accommodate for the different growing conditions to make it possible for different crops can share the available space. Separate enclosures may also be beneficial (e.g., even when only growing one type of crop) as the separate spaces may help control pests and pathogens between different growing spaces. For example, if one growing space houses a disease/diseased plant, the disease may be better confined to that growing space without threat to other growing spaces and/or plant cross-breeding may be similarly controlled (e.g., controlling cross-pollination) between growing spaces.

When different kinds of plants are grown in separate primary enclosures, it may be beneficial for each primary enclosure to employ the sidewall 106 or outer layer 202 having a low light transmissivity such that light from one enclosure does not negatively affect the growth of the plant in another enclosure. Using such sidewalls 106, users can alternate crops and environments as well as diversify the plants, such as those previously described, including fungi, bacteria, or other varieties, which they can grow in the limited space available.

FIG. 6 shows the components of the environmental exchanger 212 of FIG. 2. The environmental exchanger 212 includes a translation mechanism 600 and a mechanical coupling 602 extending from the mechanism 600 and connected to each of the enclosures 102, 500, and 502. The translation mechanism 600 may include a motor or other actuator that operates the mechanical couplings 602 to change the positions of the enclosures 102, 500, and 502 and moving the enclosures relative to each other within the secondary enclosure 104. The mechanical coupling 602 may be connected to a framework of the enclosures (for example, a ceiling frame or other support components for the enclosures) to facilitate movement of the enclosures. The mechanical coupling 602 is adequately sturdy enough to support the enclosures during the operation of the translation mechanism 600. The translation mechanism 600 may include one or more of: a lift mechanism, an expansion mechanism, and an agitation mechanism, for moving the sidewall of the primary enclosure by lifting, expanding, or agitating the sidewall as appropriate.

FIG. 7 shows an embodiment of the environmental exchanger 212, referred to as a counterbalance actuation system 700 in that the two opposing enclosures 102 and 500 are simultaneously raised or lowered, like a seesaw. The counterbalance actuation system 700 includes a lever 702 which extends from the translation mechanism 600 and two supports 704 and 706 extending from the lever 702 to the respective enclosures 102 and 500. The lever 702 and the supports 704, 706 act as the mechanical coupling 602 shown in FIG. 6, and as one enclosure is raised, the enclosure on the opposing side of the lever 702 is lowered, and vice versa.

Vertical movements 708, 710 of the enclosures 102 and 500, respectively, cause airflow 214 in each enclosure, although not necessarily in the same direction. Since each enclosure has a soft or flexible sidewall, raising the enclosure, or more specifically the sidewall of the enclosure, causes air to flow into the enclosure, while lowering the sidewall causes compression which causes air to flow out of the enclosure. The airflow 214 encourages at least one of relative humidity, temperature exchange, and/or gas exchange from the primary enclosure(s). In some embodiments, rotation 712 of the translation mechanism 600 is not limited to just raising and lowering the enclosures, but also to rotate their positions by moving horizontally. As such, the translation mechanism 600 can be configured to achieve both vertical and horizontal translations. In some examples, the translation mechanism 600 may also be raised or lowered. Since the enclosures may have pliable sidewalls, the enclosures may be lowered such that the top or roof of the enclosures are closer to the plants being grown when plants are small, and subsequently raised according to the rate at which the plants are growing. The flexible adjustment of the height of the enclosures may reduce the volume of space that needs to be conditioned.

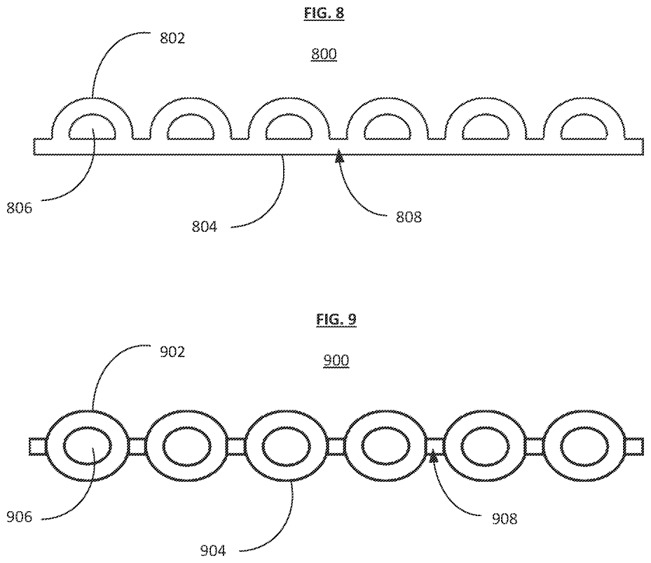

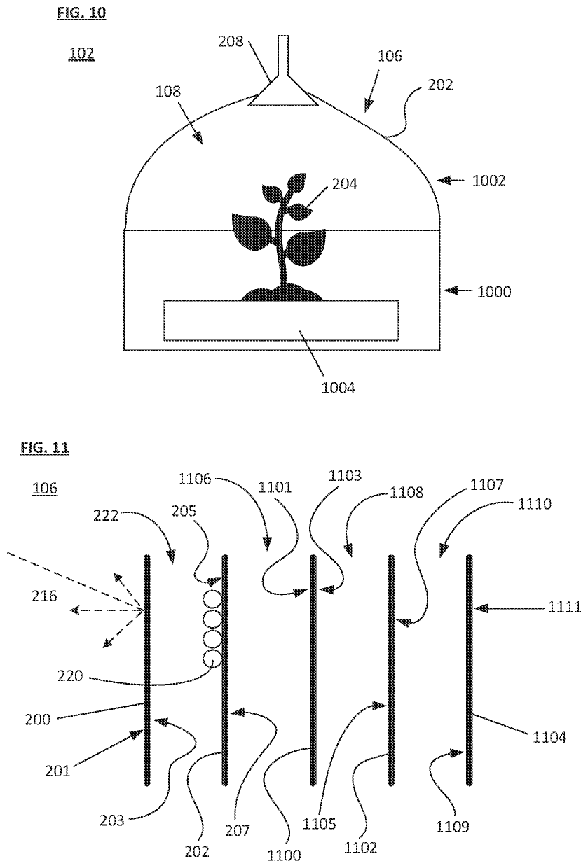

FIGS. 8 and 9 show cross-sectional views of conduit assemblies 800 and 900 (e.g., ribbon-tube layers defining a plurality of channels serving as conduits) which have first sides 802 or 902 and second sides 804 or 904 and defining a plurality of conduits 806 or 906 therebetween. The conduits may also be referred to as channels, tubes, ducts, or passages. The conduit assemblies may form one or more layers of the sidewall 106, referred to herein as conduit layers which are considered as functional layers. The conduit assemblies in the inner layer can be formed using any suitable method. In one embodiment of forming a ribbon-tube layer configuration for the conduit assembly, two sheets of polymer (for example, ePTFE) are pressed against each other with one or more wires disposed between them, after which the portions of the polymer between two neighboring conduits 806 are heated to bond the two sheets together to form a plurality of bonded sections 808 or 908 as shown. After cooling the polymer, the one or more wires are extracted from the polymer, thereby forming one or more channels serving as conduits extending between the bonded sections.

The conduits 806 in FIG. 8 are semicircular whereas the conduits 906 in FIG. 9 are circular, although any other suitable shape may be employed. The conduits may have an asymmetrical cross-section or configuration. The conduits may be varying in shape and size. The conduits may be transparent or opaque, hydrophilic or hydrophobic. The conduits may also be coated with a layer of coating (for example, to achieve the transparent, opaque, hydrophilic, or hydrophobic characteristics).

Transparent conduits may be beneficial in adjusting the opacity of the functional layer such that the transparency of the conduits may be adjustable depending on the type of material therein (e.g., more opaque liquid causes lower transparency in the conduits). Opaque conduits may be beneficial in reducing the amount of light entering or exiting the inside of the enclosure through the functional layers. Hydrophilic conduits may be beneficial in reducing surface tension of water bubbles, forcing water to spread into a thin film on plastic surfaces, and thus allowing light to pass through these surfaces with reduced distortion, also referred to as “anti-fogging”. Hydrophobic conduits may be beneficial in reducing bacterial or fungal growth on a surface thereof, for example. The conduits may be metallized by coating, depositing, or otherwise modifying the surfaces to form conduits with a layer of metal. The metallized conduits may be beneficial in conducting electricity to power an electrical component associated with the enclosure, such as the light source, for example. In some examples, some of the conduits may be filled with a solid material instead of fluid such as gas and liquid. That is, the conduits may be filled with the solid, or semi-solid (or compliable) material that is retained within the conduits. The solid and semi-solid materials may be any suitable material including but not limited to plastics, solidifying polymers and foams, for example.

In some embodiments, each of the conduits 806 and 906 carries a different material therein. In one embodiment, a conduit may transport carbon dioxide while another conduit transports water or condensate. In one embodiment, a conduit may include therein a filament that connects to a positive end of the light source (e.g., an LED light) whereas another conduit may include therein a filament that connects to a negative end of the light source. In some examples, the filament may be a light guide or conductive wire, or any other suitable conductive member. In one embodiment, a conduit transports a heat transfer fluid, including but not limited to refrigerant. In some embodiments, the light sources may be cooled by water (for example, from the condensate formed on the outer layer) or other types of fluid (for example, refrigerant) in the neighboring conduits. In some instances, the cooling of the conduit lowers a temperature of the condensing surface (e.g., the outer layer 202) to below the dewpoint temperature so as to facilitate water vapor to form condensate on the condensing surface to be collected for reclamation (e.g., by the conduit 210). The dewpoint temperature may vary for each environment depending upon the air temperature, relative humidity, and water vapor pressure.

FIG. 10 shows an embodiment of the primary enclosure 102 with the outer layer 202 having different flexibilities. That is, the outer layer 202 has a rigid or less conformable portion 1000 and a flexible or more conformable portion 1002. In the embodiment as shown, the rigid portion 1000 extends from the base of the enclosure 102, where a container 1004 containing the growth medium 206 of the plant 204 is disposed, to a certain height (e.g., the rigid portion 1000 may extend 1 meter from the base), and the flexible portion 1002 extends between the rigid portion 1000 and the light source or irrigation 208, forming a tent-like structure. Alternatively, the positions of the rigid and flexible portions may be reversed such that the flexible portion 1002 extends from the base and the rigid portion 1000 extends between the flexible portion 1002 and the light source 208. When used in combination with the environmental exchanger 212 as shown in FIG. 6, the flexible portion 1002 changes shape as a result of the translation mechanism 600 lifting, expanding, or agitating the flexible portion 1002. As the shape of the flexible portion 1002 changes, airflow 214 is induced between the growing space 108 and the external or ambient environment 110 inside the secondary enclosure 104.

FIG. 11 shows an embodiment of the sidewall 106 when one or more additional functional layers are employed. The sidewall 106 as shown includes the inner layer 200 and the outer layer 202 as previously disclosed, as well as a first additional functional layer 1100, a second additional functional layer 1102, and a third additional functional layer 1104. It is to be noted that any number of additional functional layers may be employed, such as one, two, three, or more. The additional functional layers may also include one or more of the conduit layers as previously explained.

The inner layer 200, as previously mentioned, the inner surface 201 which diffusely reflects light 216 but is air permeable, water vapor permeable, and liquid water impermeable at atmospheric conditions to allow water vapor to pass through, causing condensation to form condensate 220 on the outer layer 202 in the space 222 defined between the outer surface 203 of the inner layer 200 and the inner surface 205 of the outer layer 202, which is water vapor impermeable and liquid water impermeable at atmospheric conditions. An inner surface 1101 of the functional layer 1100 and the outer surface 207 of the outer layer 202 define a first additional space 1106 therebetween. An inner surface 1105 of the functional layer 1100 and an outer surface 1103 of the functional layer 1102 define a second additional space 1108 therebetween. An inner surface 1109 of functional layer 1102 and an outer surface 1107 of the functional layer 1104 define a third additional space 1110 therebetween. The outer layer 202 is referred to as such because it is positioned external to the inner layer 200, but in this case the outer layer 202 is not the outermost layer of the sidewall 106. Rather, the third additional layer 1104 would be considered the outermost layer of the sidewall 106.

Each of the additional functional layers (e.g., 1100, 1102, and 1104) may be disposed externally with respect to a preceding layer (e.g., 202, 1100, and 1102, respectively) such that the space (e.g., 1106, 1108, and 1110, respectively) is maintained between at least a portion of the inner surface (e.g., 1101, 1105, and 1109, respectively) of the each of the additional functional layers and an outer surface (e.g., 207, 1103, and 1107, respectively) of the preceding layer (e.g., 202, 1100, and 1102, respectively). In some examples, the outermost layer (e.g., 1104) of the plurality of additional functional layers may be formed of a light-reflective or light-absorbent material, or includes a light-absorbent coating applied to an outer surface thereof (e.g., 1111). In some examples, the intermediate layers (i.e., the functional layers that are disposed external to the outer layer 202 but are not the outermost layer) may be made of, or include, a thermally or electrically insulative material. In some examples, the inner surface of the intermediate layers may be at least partially metallized to facilitate condensing water vapor into liquid water.

Although not shown, one or more additional functional layers may be disposed between the inner layer 200 and the outer layer 202, for example to provide additional water vapor filtration capabilities or to separate the space 222 into subspaces to fulfill different purposes, as further explained herein. In some examples, the inner layer 200 is not the innermost layer of the sidewall 106, but instead one of the functional layers may be positioned inside the inner layer 200 to define the innermost layer. In such examples, the functional layer that is the innermost layer may be transparent or at least partially transparent layer such that light travels through the innermost layer to be diffusely reflected by the inner layer 200, which in this case is an intermediate layer.

In some examples, the support structure (for example, 300, 400, or 408) may be attached to one or more of the additional functional layer(s) 1100, 1102, 1104 in order to maintain one or more of the spaces 1106, 1108, 1110. In some examples, the support structure may be attached to a portion of the layer(s), such as at or near an edge region of the layer(s) to provide structural support (e.g., attached at a top edge region from which the layer may hang like a curtain or drapery with respect to the support structure). In some examples, the support structure may be attached along the entire length of the layer(s) to provide structural support.

In some embodiments, each additional functional layer 1100, 1102, and 1104 have different properties, and each additional space 1106, 1108, and 1110 fulfill different purposes. For example, the outermost additional layer, which in this case is the third additional functional layer 1104, may be used as a “blackout layer” in the sense that the layer has a low transmissivity to inhibit or prevent most of the ambient light from entering the growing space 108 of the enclosure 102. Each of the functional layers can be independently activated via delivery of a fluid through the functional layer. For example, the additional spaces 1106, 1108, and 1110 may be referred as conditioned space, insulation space, and/or channels for wiring and/or plumbing, although not necessarily in said order.

A conditioned space operates to control the temperature. The space may be cooled or heated (using refrigerant or heated fluid, for example) according to the need of the organism 204. Therefore, the conditional space is cooled to lower the condensing surface to be below dewpoint and alternatively heated when the atmospheric temperature is below a preferred temperature.

An insulation space operates to reduce or prevent heat or energy transfer between layers. For example, the insulation space may be filled with any suitable type of insulation (e.g., argon) such that even when the outermost layer is heated as result of extended exposure to sunlight or other factors, the inner layers are cooled or maintained at a lower temperature than the outermost layer.

Channels for wiring and/or plumbing can be used to carry wires to power the light source and/or water to be supplied to the irrigation, for example. Other benefits may be appreciated by those with knowledge and skill in the art.

Additional embodiments of the sidewall 106 may incorporate flexible or adjustable porosity such that the enclosure is insulated during a certain period of time (for example, at night) and the enclosure allows for water vapor from transpiration to escape during the remaining periods of time (for example, during the day). In some embodiments, active ventilation may be implemented in addition to the passive ventilation, caused by two-way ventilation system such as an electrical air blower or fan.

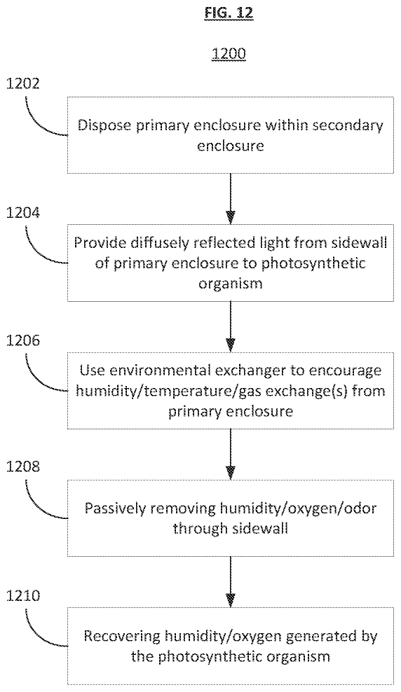

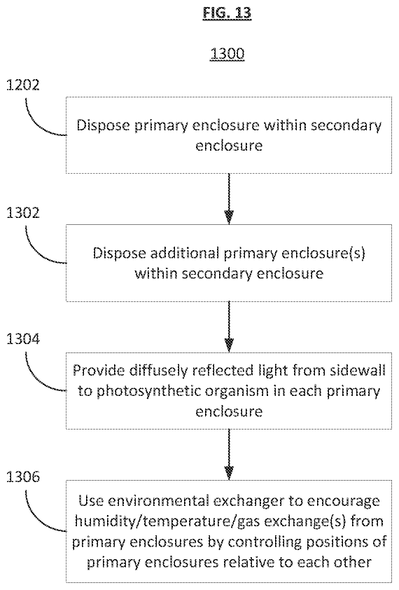

FIG. 12 shows a method or process 1200 of how a primary enclosure functions as disclosed herein. In step 1202, a primary enclosure is disposed within a secondary enclosure. In response to providing light, such as from the light source implemented in the sidewall of the primary enclosure, in step 1204, the light is diffusely reflected from the sidewall of the primary enclosure to the photosynthetic organism contained therein. In step 1206, the environmental exchanger is used to encourage humidity, temperature, and/or gas exchange(s) from the primary enclosure. The environmental exchanger may implement the translation mechanism coupled to the primary enclosure to do so, for example by moving (e.g., lifting, expanding, or agitating) the sidewall. In step 1208, humidity, oxygen (02), and/or odor is passively removed from the growing space of the primary enclosure through the sidewall. In step 1210, the humidity and/or oxygen generated by the photosynthetic organism can be recovered via the one or more conduits implemented in the sidewall.

FIG. 13 shows another method or process 1300 of how the primary enclosure functions as disclosed herein. In step 1202, the primary enclosure is disposed within the secondary enclosure, similar to FIG. 12. In step 1302, one or more additional primary enclosures are disposed within the second enclosure. In step 1304, light is diffusely reflected from the sidewall in each of the primary enclosures, and the reflected light is provided to the photosynthetic organism disposed within the enclosures. In step 1306, the environmental exchange is used to encourage exchanges of humidity, temperature, and/or gas between the primary enclosures and the external or ambient environment within the secondary enclosure. This is achieved by controlling the positions of the primary enclosures relative to each other, such as using the counterbalance actuation system.

There are numerous advantages in using the controlled environment agriculture system 100 as well as the multi-layered sidewalls 106 as disclosed herein. One example can be the ability to retrofit a preexisting infrastructure (for example, a building that was previously used for a different purpose and is currently decommissioned or unoccupied) as the secondary enclosure 104 to house one or more primary enclosures for growing one or more types of photosynthetic organisms allows for faster and more economical implementation of growing spaces for these organisms, since there is no need to build an entirely new infrastructure to accommodate for the optimal conditions in which the organisms could grow. Furthermore, since the size and shape of each primary enclosure can be changed in some instances to fit in the available spaces within the preexisting infrastructure, the available spaces can be used more efficiently in those instances. The primary enclosures are modular in the sense that they are smaller and more compact, so they can be arranged in a more compact arrangement (e.g., like puzzle pieces) in the available spaces to achieve better efficiency.

In some embodiments, the primary enclosures 102 can be separately and individually removed or relocated. For example, when the building or infrastructure (that is, the secondary enclosure) is no longer being used for indoor agriculture, the user can relocate the primary enclosures to another facility or building without leaving behind the installations for indoor agriculture which may have been built inside the infrastructure. In fact, the use of the primary enclosures as disclosed herein reduces or minimizes the need for such installations, because the primary enclosures are packable and transportable such that the user can complete the setup for indoor agriculture by disposing the individual primary enclosures within the secondary enclosure without additional modifications, permanent or temporary, to the infrastructure of the secondary enclosure. In some examples, the primary enclosures are collapsible or foldable (e.g., including a collapsible framework in the manner of camping tents) to facilitate the process of setting up the primary enclosures with minimal effort and time.

Furthermore, the breathability of the sidewalls 106 may facilitate an ability of the primary enclosures to control the humidity inside, thereby reducing the risk of mold, mildew, or other types of fungus growing inside the enclosures. By allowing water vapor to escape the inner layer and be captured by the conduit coupled with the outer layer, the water obtained from transpiration and condensation can be reused. In various examples, the breathability may contribute to mitigating odor inside the enclosures due to the air exchange that takes place between inside the enclosures and the external ambient environment.

In various examples, the sidewalls 106 also allow for a more precise control of the lighting inside the primary enclosures. When the outermost layer of the multi-layer sidewall 106 has low transmissivity, the growing space inside the enclosure may be less affected (e.g., minimally affected) by the ambient environment, so the light source inside the enclosure is the main source of light affecting the growth of the organism inside. The diffusely reflective property of the inner surface of the sidewall 106 contributes to an increased efficiency of the lighting due to the inner surface dispersing the light that reflects off the surface, as previously explained.

Although various examples have been provided in the context of terrestrial agriculture, the controlled environment agriculture system may also be used in aquaculture arrangements as well as the emerging field of space farming, where studies are performed to see how crops can be cultivated for food and other material in space, or an extraterrestrial location.

In the aquaculture arrangements, the photosynthetic organism can be of any suitable type that grows in aquacultural environments, for example phototrophs including but not limited to types of bacteria, algae, protists, phytoplankton, etc. Similar to the other examples disclosed herein, aquaculture benefits from controlled light, humidity, and/or temperature within the growing environment so as to provide the preferred conditions for the photosynthetic organism to grow and reproduce. For example, the growing environment may be adjustable to replicate the natural growing environments that facilitate fastest growth of the organism, such as the photic zone in a body of water in which the photosynthesis rate exceeds the respiration rate of the organism. The light provided may be natural (e.g., solar energy from the sun) or artificial (e.g., LED light affixed to the enclosure). In some examples, the enclosure may be moved via the translation mechanism to facilitate changes in hydrostatic pressure and/or turbulent mixing to control the spatial distribution of the organisms within the enclosure such that the organisms are evenly distributed throughout the growing space to reduce competition for nutrient, thereby facilitating growth.

With regard to space farming, possible extraterrestrial locations may include a space station or space colony, or the surface of a distant planet (e.g. Mars) or satellite (e.g. the Moon) away from Earth. One of the challenges faced by researchers in this field is that the amount of photonic energy provided to the crop in such environments may be different from (e.g., considerably less than or considerably more than) what is available on Earth. Considering the limited energy source that must be used for other life-sustaining purposes such as providing water and air to the environment, farmers in this environment cannot depend on artificial lighting to provide all the light necessary for the growth of the crops. Insufficient availability of light causes limited photosynthesis to take place, which results in fewer crops for cultivation or a decrease in the crops' biomass. To have a fully sustainable crop source, the reflective layers can be used to gather as much of the available light, natural and artificial, and reflect the light in a way that maximizes the amount of light received by the crops.

The modular primary enclosures additionally provide the benefit of maximizing the number of crops that can be grown within the limited spaces available in space station or space colony. The capability of arranging the modular enclosures at a high density concentration in the available spaces without the risk of cross-contamination or unintended cross-pollination is beneficial in allowing the users to grow not only more crops but also a greater variety of crops for those in the space station or space colony.

Inventive concepts have been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A controlled environment agriculture system, the system comprising:
an inner layer comprising an inner surface and an outer surface, wherein:
the inner layer is air permeable, water vapor permeable, and liquid water impermeable at atmospheric conditions,
the inner surface of the inner layer has a diffuse reflectivity of at least 90%, and
the inner layer defines a first enclosure forming a growing space for one or more photosynthetic organisms; and
an outer layer comprising an inner surface and an outer surface, wherein:
the outer layer is water vapor impermeable and liquid water impermeable at atmospheric conditions, and
the outer layer defines a second enclosure comprising an interior space such that the first enclosure is disposed within the interior space of the second enclosure and a primary spacing is maintained between at least a portion of the outer surface of the inner layer and the inner surface of the outer layer.

2. The system of claim 1, further comprising a support structure attached to at least one of the inner and outer layers to maintain the primary spacing.

3. The system of claim 1, wherein the outer layer further comprises a support structure integrated therein to maintain the primary spacing.

4. The system of claim 1, wherein the inner layer further comprises a support structure integrated therein to maintain the primary spacing.

5. The system of claim 2, wherein the support structure is a rigid member.

6. The system of claim 2, further comprising at least one additional functional layer disposed externally with respect to the outer layer, wherein the additional functional layer comprises an inner surface and an outer surface and maintains a secondary spacing between at least a portion of the outer surface of the outer layer and the inner surface of the additional functional layer.

7. The system of claim 6, wherein the support structure is attached to the additional functional layer to maintain the secondary spacing.

8. The system of claim 6, wherein the secondary spacing defines one or more of: a conditioned space, an insulation space, a wiring channel, or a plumbing channel.

9. The system of claim 6, wherein the additional layer is independently activatable via delivery of a fluid through the additional layer.

10. The system of claim 6, wherein the outer layer or the additional layer further comprises one or more conduits configured to transport a heat transfer fluid.

11. The system of claim 6, further comprising a plurality of additional functional layers disposed externally with respect to the outer layer, wherein:
each of the plurality of additional functional layers is disposed externally with respect to a preceding one of the plurality of additional functional layers such that the secondary spacing is maintained between at least a portion of an inner surface of the each of the additional functional layers and an outer surface of the preceding one of the plurality of additional functional layers.

12. The system of claim 11, wherein an outermost one of the plurality of additional functional layers is formed of a light-absorbent material or includes a light-absorbent coating applied to an outer surface thereof.

13. The system of claim 12, wherein at least one of the plurality of additional functional layers disposed internally with respect to the outermost one of the plurality of additional functional layers comprises a thermally or electrically insulative material.

14. The system of claim 12, wherein an inner surface of the at least one of the plurality of additional functional layers disposed internally with respect to the outermost one of the plurality of additional functional layers is at least partially metallized.

15. A controlled environment agriculture system for promoting the growth of a photosynthetic organism within the controlled environment agriculture system, the system comprising:
a primary enclosure defining a growing space housing the photosynthetic organism within the primary enclosure, the primary enclosure having an inner layer separating the growing space from a moisture-collection space external to the inner layer,
wherein the inner layer is air permeable, water vapor permeable, and liquid water impermeable at atmospheric conditions,
wherein the inner layer maintains an air pressure gradient between the growing space and the moisture-collection space that coveys water vapor from the growing space to the moisture-collection space, and
wherein the inner layer and the air pressure gradient removes an excessive moisture from the growing space to inhibit at least one of a bacterial and a fungal growth within the growing space.

16. The system of claim 15, wherein the inner layer has a diffuse reflectivity of at least 90%.

17. The system of claim 15, further comprising:
an outer layer disposed proximate to at least a portion of the inner layer to further define the moisture-collection space, wherein the outer layer is water vapor impermeable and liquid water impermeable at atmospheric conditions.

18. A method of controlling a moisture level within a growing space housing a photosynthetic organism, the method comprising:
separating the growing space from an adjacent moisture-collection space with an inner layer that is air permeable, water vapor permeable, and liquid water impermeable at atmospheric conditions;
applying an air pressure gradient wherein the growing space is maintained at a greater air pressure than the moisture-collection space; and
transferring moisture from the growing space to the moisture-collection space via the inner layer.
